(19) United States
(12) Patent Application Publication
(10) Pub. No.: US 2013/0202149 A1
(43) Pub. Date: Aug. 8, 2013

(54) SPEAKER APPARATUS WITH N-DIVIDED MAGNET STRUCTURE

(71) Applicant: Samsung Electronics Co., Ltd., Gyeonggi-do (KR)

(72) Inventor: Jun YOON, Gyeonggi-do (KR)

(73) Assignee: Samsung Electronics Co., Ltd., Gyeonggi-do (KR)

(21) Appl. No.: 13/757,140

(22) Filed: Feb. 1, 2013

(30) Foreign Application Priority Data
Feb. 2, 2012 (KR) 10-2012-0010723

(51) Int. Cl. H04R 9/02

(52) U.S. Cl. CPC H04R 9/02
USPC 381/433

(57) ABSTRACT

A speaker apparatus with an N-divided magnet structure for an audio device includes a hollow-type speaker frame, at least two unit magnets arranged within the hollow-type speaker frame, a voice coil installed adjacent to the unit magnets, and a diaphragm. The at least two unit magnets are arranged at predetermined intervals on a magnet arrangement line, thereby excluding an unnecessary part of a magnet, and at least one divided unit magnet is formed. Thus, the abuse of a magnet substrate by magnet cutting of a closed loop shape is prevented and a cost reduction of the audio device is promoted.

### PRIORITY

This application claims priority under 35 U.S.C. §119(a) to a Korean Patent Application filed in the Korean Intellectual Property Office on Feb. 2, 2012 and assigned Serial No. 10-2012-0010723, the contents of which are incorporated herein by reference.

### BACKGROUND OF THE INVENTION

1. Field of the Invention

The present invention relates generally to a speaker for an electronic device.

2. Description of the Related Art

A speaker apparatus for an audio device may be classified into a horn speaker apparatus, a system speaker apparatus composed of a woofer, a midrange, and a tweeter and used in a High-Fidelity (HiFi) audio system such as a component system and covering a constant frequency band, a general speaker apparatus covering the entire frequency band by one unit, a lightweight, ultra-slim type micro speaker apparatus used in a small electronic device such as a subminiature camcorder, a receiver used in a mobile communication terminal, an earphone having a structure partly inserted into a user's ear, and a boozer playing back only a specific band frequency.

In a conventional speaker apparatus, at least one magnet is installed outside or inside a yoke, and a bobbin having a voice coil wired thereon is positioned above the magnet. It is desirable that the voice coil is installed in a position not contacting with but overlapping the magnet. The conventional speaker apparatus can also have a vibration gap (i.e., a magnetic gap) provided between a pair of magnets, and the voice coil interposed therebetween. Also, an upper part of the bobbin is fixed at its outer circumference to an upper part of a frame and a lower part thereof, respectively, and is typically fixed at its center to a diaphragm having punctures of a circle shape and a damper.

This speaker apparatus has a structure in which, by an attraction and repulsion force generated by reaction according to Fleming's left-hand rule between a non-alternating (i.e., Direct Current (DC)) flux generated from a fixed magnetic circuit (i.e., magnet) and an alternating (i.e., Alternating Current (AC)) rotation flux generated from an up/down movable voice coil, the diaphragm and the voice coil vibrate up/down and generate a sound corresponding to a driving signal. In recent years, because a single magnet scheme is relatively restricted in size and cannot form a uniform magnetic flux density on a facing yoke surface, the trend has been to arrange a pair of magnets (i.e., an inner magnet and an outer magnet) between which is interposed a voice coil, and form the uniform magnetic flux density.

Another recent trend has been to incorporate a speaker apparatus into a personal portable device such as a smart phone and a tablet Personal Computer (PC) for providing voice and video multimedia in addition to a basic phone call function. Thus, device manufacturers have been working to develop a low-cost, high output speaker apparatus.

However, because the magnet mounted in the speaker apparatus, particularly, the outer magnet is realized in a closed loop form of a circle or oval shape, there is a problem that spare parts of a magnet substrate that is cut in a form applied to the speaker apparatus cannot be recycled, thereby increasing cost of manufacture.

### SUMMARY OF THE INVENTION

An aspect of the present invention is to substantially solve at least the above problems and/or disadvantages and to provide at least the advantages below. Accordingly, an aspect of the present invention is to provide a speaker apparatus with an N-divided magnet structure, realized to accomplish a conventional level of performance while reducing cost of manufacture.

Another aspect of the present invention is to provide a speaker apparatus with an N-divided magnet structure, realized to efficiently utilize a magnet substrate and reduce cost of manufacture.

A further aspect of the present invention is to provide a speaker apparatus with an N-divided magnet structure, realized to achieve a conventional level of performance while reducing cost of manufacture, by cutting a magnet substrate in a desired size and accomplishing efficient application.

The above aspects are achieved by providing a speaker apparatus with an N-divided magnet structure.

According to one aspect of the present invention, a speaker apparatus for an audio device includes a hollow-type speaker frame, at least two unit magnets arranged within the hollow-type speaker frame, a voice coil installed adjacent to the unit magnets, and a diaphragm vibrating by electric current applied to the voice coil. The at least two unit magnets are continuously arranged at regular intervals on a magnet arrangement line.

According to another aspect of the present invention, a speaker apparatus includes a hollow-type speaker frame, at least two unit outer magnets arranged within the hollow-type speaker frame, the unit other magnets being spaced a regular interval apart and being arranged on a trajectory of a hollow-type closed loop shape, at least one inner magnet arranged in a hollow part of the hollow-type speaker frame in a size smaller than that of the trajectory of the unit outer magnets, a voice coil interposed in a magnetic gap formed by the unit outer magnets and the inner magnet, and a diaphragm vibrating by electric current applied to the voice coil.

### BRIEF DESCRIPTION OF THE DRAWINGS

The above and other objects, features and advantages of the present invention will become more apparent from the following detailed description when taken in conjunction with the accompanying drawings in which:

FIGS. 1 and 2 illustrate front and rear perspective diagrams, respectively, of a portable terminal employing a speaker apparatus according to an embodiment of the present invention;

FIGS. 3A and 3B front and rear perspective diagrams, respectively, of a speaker apparatus according to the present invention;

FIG. 4 illustrates a combined state of a speaker apparatus according to the present invention;

FIG. 5 illustrates a state in which magnets are applied to a frame of a speaker apparatus according to the present invention;

FIGS. 6A and 6B illustrate states of cutting, from substrates, a magnet applied to a speaker apparatus according to the conventional art and according to the present invention, respectively;

FIGS. 7A-7E illustrate various magnet arrangements applied to a frame of a speaker apparatus according to the present invention; and

FIG. 8 illustrates Sound Pressure Level (SPL) simulation test results of a speaker apparatus according to the present invention and a speaker apparatus according to the conventional art.

### DETAILED DESCRIPTION OF EMBODIMENTS OF THE INVENTION

Embodiments of the present invention will be described herein below with reference to the accompanying drawings. In the following description, well-known functions or constructions are not described in detail for the sake of clarity and conciseness.

The present invention relates to a speaker for an electronic device, which includes, for example, a portable terminal, a mobile communication device, a cellular phone, a smart phone and a laptop computer.

In the following description, a portable terminal is illustrated as an audio device, and a speaker apparatus applied to the portable terminal is described. However, the speaker apparatus according to the present invention may be applicable to various electronic devices outputting sound.

The portable terminal according to the present invention includes various devices with speaker apparatuses, such as a mobile phone, a mobile pad, a media player, a tablet computer, a handheld computer, and a Personal Digital Assistant (PDA).

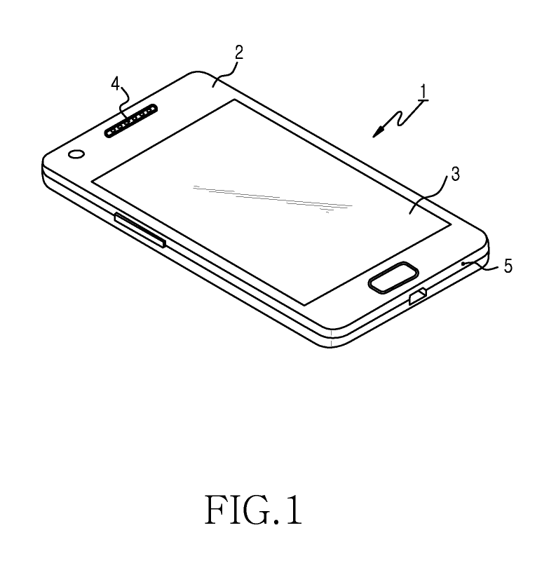

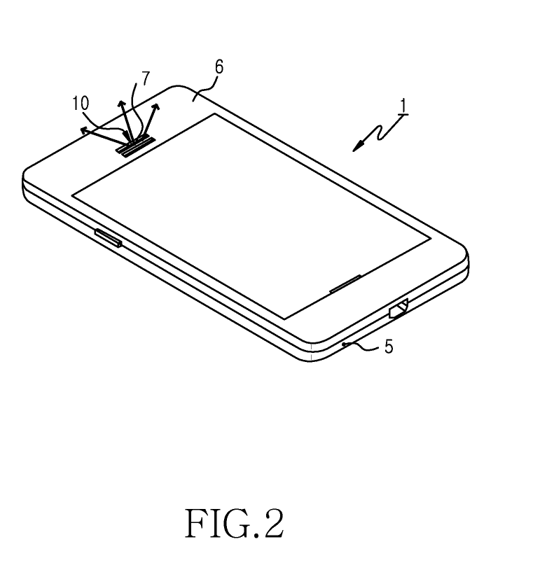

FIGS. 1 and 2 illustrate front and rear perspective diagrams, respectively, of a portable terminal employing a speaker apparatus according to an embodiment of the present invention.

Referring to FIGS. 1 and 2, a display unit 3 is installed in a front surface 2 of a portable terminal 1. The display unit 3 is a touch screen device using a high quality thin film panel, such as a smart phone. An earpiece 4 capable of receiving a caller's voice is installed at an upper side of the display unit 3. A microphone 5 for forwarding voice to a caller is installed at a lower side of the display unit 3.

A speaker hole 7 is provided at a case frame of a rear surface 6 of the portable terminal 1. A speaker apparatus 10 according to the present invention is installed in an inner part of the portable terminal 1 corresponding to the speaker hole 7. Accordingly, the portable terminal 1 can be used as a means for outputting sound when a multimedia function is used.

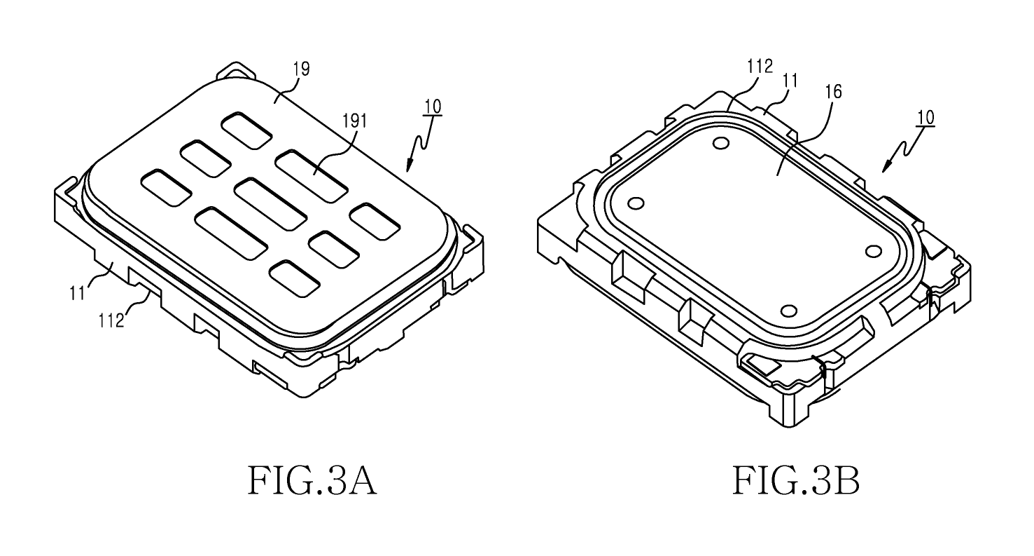

FIGS. 3A and 3B illustrate front and rear perspective diagrams, respectively, of a speaker apparatus according to the present invention.

The speaker apparatus 10 is installed as one assembly in the portable terminal 1. Although not illustrated, a bushing of a constant shape can be a protrusion formed on an inner surface of the case frame of the portable terminal 1, and the speaker apparatus 10 is closely mounted on the bushing and is electrically connected to a main board of the portable terminal 1.

FIG. 3A illustrates a front perspective diagram of the speaker apparatus 10. A speaker cover 19 is laminated of metal on a speaker frame 11, and a plurality of speaker sound discharge holes 191 is provided in the speaker cover 19.

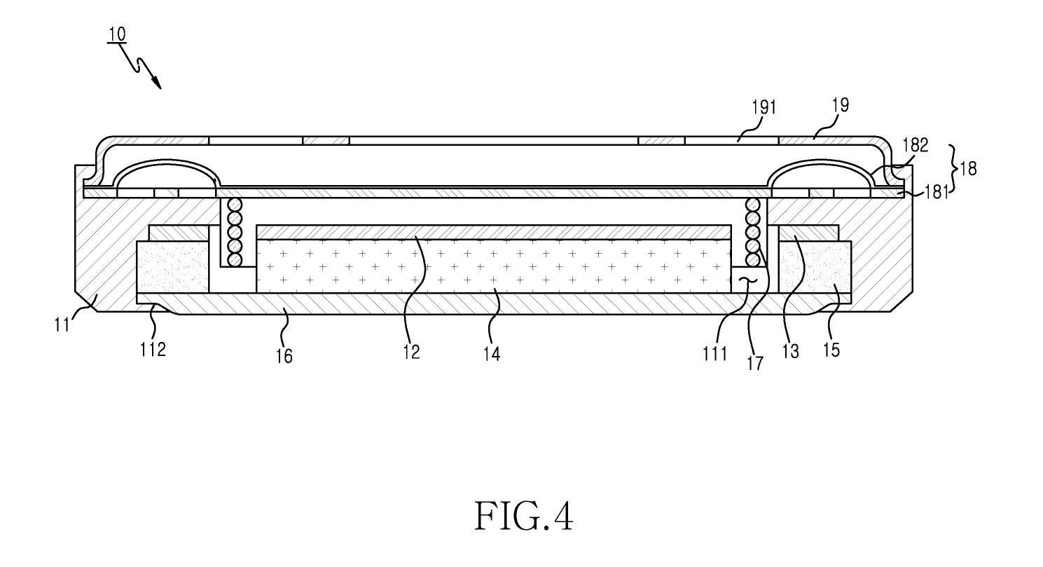

FIG. 3B illustrates a rear perspective diagram of the speaker apparatus 10. A yoke 16 is fixed to a bottom part 112 of the speaker frame 11. The yoke 16 supports magnets (14 and 15 of FIG. 4) installed within the speaker frame 11 and maintains the appearance of the speaker apparatus 10.

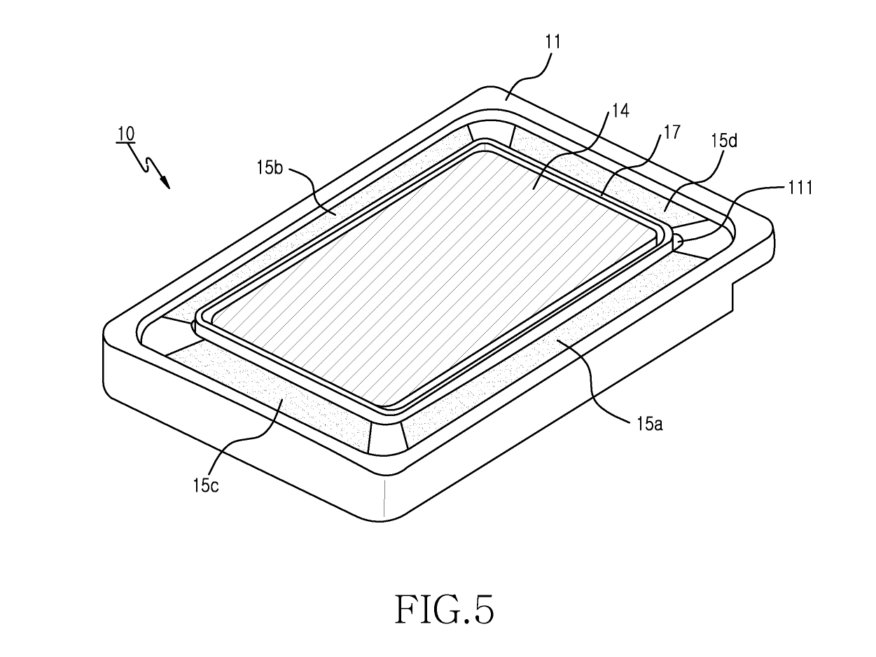

FIG. 4 illustrates a combined state of a speaker apparatus according to the present invention. FIG. 5 illustrates a state in which magnets are applied to a frame of the speaker apparatus according to the present invention.

Referring to FIGS. 4 and 5, in the speaker apparatus 10 according to the present invention, an outer plate 13 and an inner plate 12 are installed in the bottom part 112 of a hollow-type speaker frame 11. The outer plate 13 and the inner plate 12 can be of metal material. The outer plate 13 is of a closed loop shape, and can be mounted on step parts protrusively formed inside a hollow part within the speaker frame 11. Also, the inner plate 12 can be installed by being laminated together with a bobbin including the voice coil 17. An inner magnet 14 can then be installed in the inner plate 12, and an outer magnet 15 can be installed in the outer plate 13 along an inner circumference of the speaker frame 11. A plate type yoke 16 is then laminated at a lower side of the speaker frame 11, thereby completing construction of the bottom part of the speaker apparatus 10. The outer magnet 15 and the yoke 16 can be fixed to the speaker frame 11 of synthetic resin material in an insert molding manner. However, the present invention is not limited thereto, and the outer magnet 15 and the yoke 16 may be fixed in the known coupling manner of screw coupling or bonding. The voice coil 17 may be installed adjacent to the inner magnet 14 and outer magnet 15.

Also, a voice coil 17, a damper 181 and a diaphragm 182 are sequentially laminated on the speaker frame 11 and a plate type speaker cover 19 is fixed to an upper part of the speaker frame 11, thereby completing construction of the speaker apparatus 10. The aforementioned plate type speaker cover 19 has a plurality of speaker sound discharge holes 191 for discharging speaker sound. The speaker apparatus 10 according to the present invention is constructed to provide a constant magnetic gap 111 between the inner magnet 14 and the outer magnet 15, and interpose the voice coil 17 in the magnetic gap 111 between the inner magnet 14 and the outer magnet 15. Accordingly, a speaker sound output of excellent performance is produced because a distance is constant between the inner magnet 14 and the outer magnet 15 arranged at left and right sides of the voice coil 17 and a uniform magnetic flux density is formed.

Accordingly, by an attraction and repulsion force generated by a reaction according to Fleming's left-hand rule between a DC flux generated from a magnetic circuit of the magnets 14 and 15 and an AC rotation flux generated from the voice coil 17 arranged such that its up/down movement is made possible by the diaphragm 182 and the damper 181, the aforementioned diaphragm 182 and voice coil 17 vibrate up/down and generate sound corresponding to a driving signal.

As illustrated in FIG. 5, according to the present invention, the outer magnet 15 is installed such that a plurality of divided unit magnets 15a, 15b, 15c, and 15d, not a single magnet forming a closed loop, is connected on a closed loop. The unit magnets 15a, 15b, 15c, and 15d do not contact each other, and are of a relative bar form.

The construction of FIG. 5 provides four unit outer magnets 15a, 15b, 15c, and 15d and one inner magnet 14, and installs the voice coil 17 in the magnetic gap 111 between the four unit outer magnets 15a, 15b, 15c, and 15d and the inner magnet 14. The voice coil 17 may be installed adjacent to the outer magnets 15a, 15b, 15c, and 15d.

For improved efficiency, the speaker apparatus can include an increased wire diameter of a voice coil and the number of turns thereof to enable a large allowed input or, to drive the speaker apparatus, the size of the magnet may be larger to increase a magnetic flux density in a magnetic gap or a large magnetic flux density material may be used as the material of the magnet.

By this principle, a plurality of unit outer magnets may be arranged in suitable positions to have the same magnetic flux density as the existing single magnet of the closed loop shape. Preferably, in the present invention, magnets are applied to a speaker apparatus of a rectangular form, and bar type unit outer magnets 15a, 15b, 15c, and 15d are applied to the remaining straight-line parts instead of to four corners. The aforementioned magnets 15a, 15b, 15c, and 15d can be fixed to a speaker frame of synthetic resin material in an insert molding manner, and can also be fixed by bonding. Also, it may be desirable that a magnet-excluded part is a part positioned as far away from the voice coil as possible.

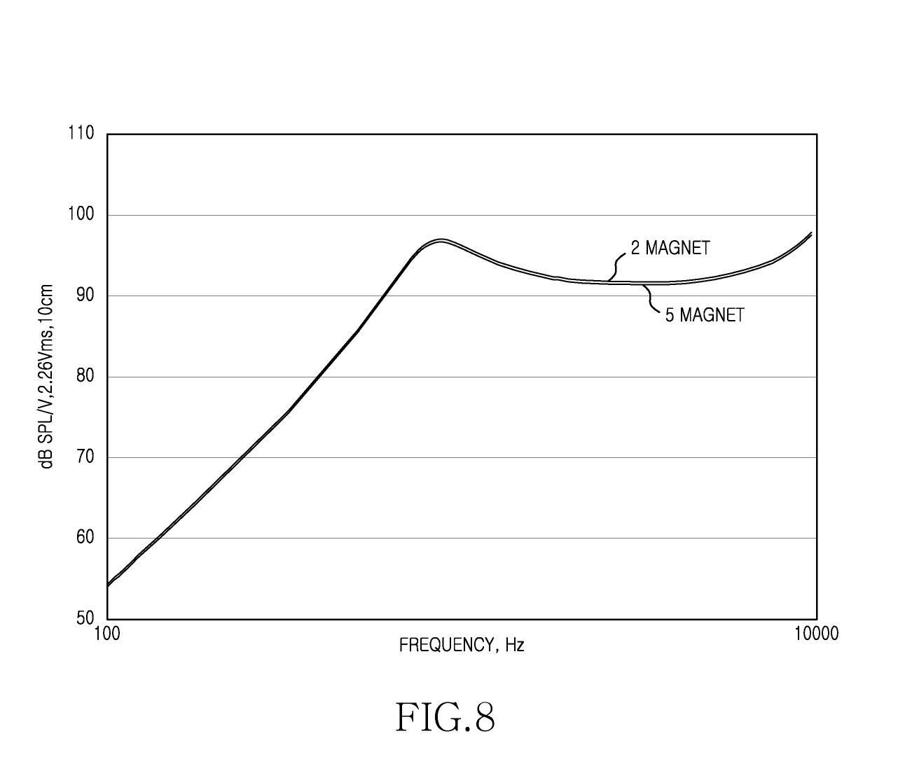

FIG. 8 illustrates SPL simulation test results of a speaker apparatus according to the present invention and a speaker apparatus according to the conventional art. FIG. 8 illustrates sound pressure levels measured when a force of 2.26 volts (V) is applied at a distance of 10 cm in a box space of 2 cc.

Referring to FIG. 8, when a speaker apparatus according to the present invention changes a magnet structure from a single outer magnet of a closed loop type to four unit outer magnets without a change of other parts, the SPL test results illustrate that a magnetic flux density was decreased about 3% from 5100 Gausses to 4890 Gausses, and a sound pressure was decreased about 0.3 decibels (dB) to 0.5 dB throughout the band, but it could be appreciated that these numerical decreases were merely small differences in terms of the performance of the speaker apparatus, and virtually the same performance was realized.

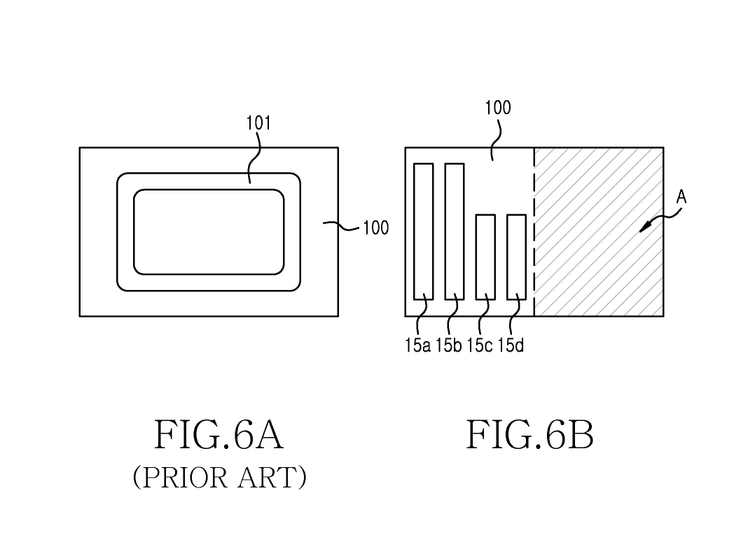

FIGS. 6A and 6B illustrate states of cutting, from substrates, a magnet applied to a speaker apparatus according to the conventional art and according to the present invention, respectively.

As illustrated in FIG. 6A, after manufacturing an outer magnet 101 of a closed loop shape using a magnet substrate 100, the remainder substrate was disposed in the conventional art because it was not recyclable.

As illustrated in FIG. 6B, if four single outer magnets 15a, 15b, 15c, and 15d are constructed, a spare part is as much generated as an ‘A’ part of a magnet substrate 100, so the space part can be used for producing separate magnets for other speaker apparatuses. This reduces cost because additional magnets for the speaker apparatus can be produced from the same magnet substrate, in contrast with the conventional art.

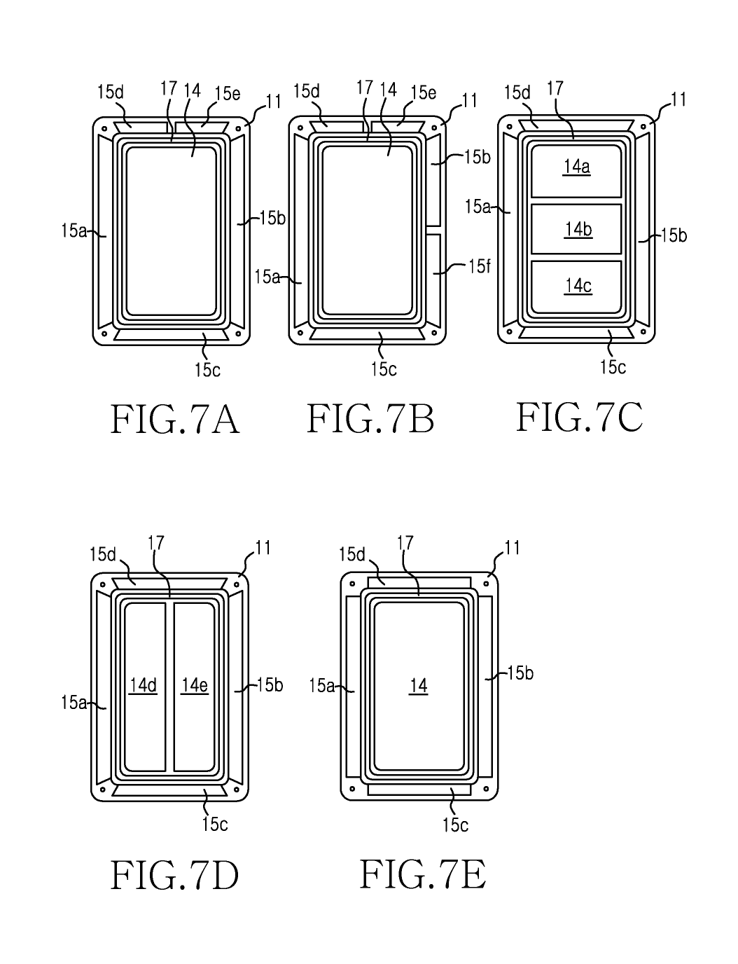

FIGS. 7A-7E illustrate various arrangements of magnets applied to a frame of a speaker apparatus according to the present invention.

As described above, the inner magnet and the outer magnet may be realized by spacing a plurality of unit magnets apart at regular intervals in various manners so as not to diminish the performance of a speaker apparatus.

As illustrated in FIGS. 7A and 7B, a plurality of unit outer magnets 15a, 15b, 15c, 15d, 15e, and 15f is arranged in the edges of a speaker frame 11, an inner magnet 14 is arranged in the center of the speaker frame 11, and a voice coil 17 is interposed between the plurality of unit outer magnets 15a, 15b, 15c, 15d, 15e, and 15f and the inner magnet 14. In FIGS. 7A and 7B, the outer magnet increases magnet subdivision and five or six unit magnets 15a, 15b, 15c, 15d, 15e, and 15f are arranged. Additional unit magnets may be utilized, as well.

As illustrated in FIGS. 7C and 7D, a plurality of unit outer magnets 15a, 15b, 15c, and 15d is arranged in the edges of a speaker frame 11, inner magnets 14a, 14b, 14c, 14d, and 14e are arranged in the center of the speaker frame 11, and a voice coil 17 is interposed between the plurality of unit outer magnets 15a, 15b, 15c, and 15d and the inner magnets 14a, 14b, 14c, 14d, and 14e. In FIGS. 7C and 7D, the inner magnets are subdivided and additional unit inner magnets 14a, 14b, 14c, 14d, and 14e are arranged. It is not necessary to realize unit inner magnets by increasing the amount thereof within a range, in order to maintain the performance of a speaker apparatus.

FIG. 7E illustrates a 5-magnet structure having unit outer magnets 15a, 15b, 15c, and 15d and an inner magnet 14. The unit outer magnets 15a, 15b, 15c, and 15d are arranged in a rectangular bar shape having vertical corners as being cut from a substrate in FIGS. 6A-6B.

Although not illustrated, unit magnets cut out in a bar form from a substrate according to the present invention may have a basic bar shape while both ends may be slightly deformed in various shapes. For example, unit magnets may have various shapes according to a shape of a speaker frame applied or an arrangement structure of the unit magnets.

In the accompanying drawings, unit outer magnets are arranged at regular intervals on a magnet arrangement line having a rectangular closed loop. However, the present invention is not limited thereto, and the closed loop shape on the magnet arrangement line may be of various shapes such as a circle, a rectangle, an oval, and a polygon.

According to the present invention, by excluding an unnecessary part of a magnet applied to a speaker apparatus and forming and arranging at least one divided unit magnet, the abuse of a magnet substrate resulting from magnet cutting of a closed loop shape is prevented and a cost reduction of the audio device is promoted.

While the invention has been shown and described with reference to certain embodiments thereof, it will be understood by those skilled in the art that various changes in form and details may be made therein without departing from the spirit and scope of the invention as defined by the appended claims.

what is claimed is:

1. A speaker apparatus with an N-divided magnet structure for an audio device, comprising:
a hollow-type speaker frame;
at least two unit magnets arranged within the hollow-type speaker frame;
a voice coil installed adjacent to the unit magnets; and
a diaphragm which vibrates by electric current applied to the voice coil,
wherein the at least two unit magnets are arranged at predetermined intervals on a magnet arrangement line.

2. The speaker apparatus of claim 1, wherein a spaced part between the at least two unit magnets is formed in a part positioned farthest from the voice coil.

3. The speaker apparatus of claim 1, wherein the speaker frame is formed of synthetic resin material, and the unit magnets are fixed to the speaker frame in an insert molding manner.

4. The speaker apparatus of claim 1, wherein the at least two unit magnets are of a bar shape.

5. The speaker apparatus of claim 1, wherein a trajectory on the magnet arrangement line on which the at least two unit magnets are installed is of a hollow-type closed loop shape, and the at least two unit magnets are applied in a bar shape to straight-line parts of the trajectory of the hollow-type closed loop shape.

6. The speaker apparatus of claim 1, wherein a trajectory on the magnet arrangement line on which the at least two unit magnets are installed is of a hollow-type closed loop shape, and is formed in one of circular, triangular, rectangular, and polygonal shapes.

7. The speaker apparatus of claim 1, wherein the audio device is a portable terminal which outputs speaker sound.

8. A speaker apparatus with an N-divided magnet structure for an audio device, comprising:
a hollow-type speaker frame;
at least two unit outer magnets arranged within the hollow-type speaker frame, the unit outer magnets being spaced apart and being arranged on a trajectory of a hollow-type closed loop shape;
at least one inner magnet arranged in a hollow part of the hollow-type speaker frame in a size smaller than that of the trajectory of the unit outer magnets;
a voice coil interposed in a magnetic gap formed by the unit outer magnets and the inner magnet; and
a diaphragm which vibrates by electric current applied to the voice coil.

9. The speaker apparatus of claim 8, wherein a spaced part between the at least two unit outer magnets is formed in a part positioned farthest from the voice coil.

10. The speaker apparatus of claim 8, wherein the speaker frame is formed of synthetic resin material, and the unit outer magnets are fixed to the speaker frame in an insert molding manner.

11. The speaker apparatus of claim 8, wherein the at least two unit outer magnets are of a bar shape.

12. The speaker apparatus of claim 8, wherein the at least two unit outer magnets are applied in a bar shape to straight-line parts of the trajectory of the closed loop shape.

13. The speaker apparatus of claim 8, wherein the trajectory of the closed loop shape on a magnet arrangement line is formed in one of circular, triangular, rectangular, and polygonal shapes.

14. The speaker apparatus of claim 8, wherein at least two inner magnets are spaced apart and are arranged.

15. The speaker apparatus of claim 14, wherein the at least two inner magnets are of a bar shape.

16. The speaker apparatus of claim 8, wherein the audio device is a portable terminal that outputs speaker sound.

17. An electronic device comprising:
a speaker apparatus with an N-divided magnet structure for an audio device, comprising:
a hollow-type speaker frame;
at least two unit magnets arranged within the hollow-type speaker frame;
a voice coil installed adjacent to the unit magnets; and
a diaphragm which vibrates by electric current applied to the voice coil, and
a display unit included in the electronic device,
wherein the at least two unit magnets are arranged at predetermined intervals on a magnet arrangement line.
